(19) United States
(12) Patent Application Publication
(10) Pub. No.: US 2021/0137096 A1
(43) Pub. Date: May 13, 2021

(54) COMPOSITIONS AND METHODS FOR CONTROLLING PLANT OR CROP SIZE IN A CONTROLLED ENVIRONMENT

(71) Applicant: BASF AGRICULTURAL SOLUTIONS SEED US LLC, Florham Park, NJ (US)

(72) Inventors: Raymond Douglas SHILLITO, Morrisville, NC (US); Jiyi ZHANG, Research Triangle Park, NC (US); Elizabeth DOZIER, Raleigh, NC (US); Sarah BONEFAS, Research Triangle Park, NC (US)

(21) Appl. No.: 16/958,382

(22) PCT Filed: Dec. 21, 2018
(86) PCT No.: PCT/US2018/067045

§ 371 Date: Jun. 26, 2020

Related U.S. Application Data
(60) Provisional application No. 62/612,111, filed on Dec. 29, 2017.

(51) Int. Cl. A01M 21/04; A01N 57/20; A01N 43/653; A01N 43/80; A01N 33/12; A01N 33/26; A01N 43/50; A01N 47/34; A01C 1/06

(52) U.S. Cl. CPC A01M 21/043; A01N 57/20; A01N 43/653; A01N 43/80; A01C 1/06; A01N 33/26; A01N 43/50; A01N 47/34; A01N 33/12

(57) ABSTRACT

The disclosure provides for compositions and methods of controlling and/or regulating plant size in a controlled environment, for example, a greenhouse or environment for the purpose of testing plants. In another aspect, the disclosure provides for methods of dwarfing plant growth by utilizing a composition or method described herein. The disclosure further provides for methods described herein wherein a plant growth regulator is used to stunt plant growth in order enable more consistent and/or accurate plant feature and property testing.

### FIELD

This application claims priority to U.S. Provisional Patent Application 62/612,111 filed Dec. 29, 2017, the disclosure of which is incorporated herein by reference in its entirety.

The disclosure provides for compositions and methods for controlling and/or regulating plant size in a controlled environment for example, for testing and/or characterizing plants, for example, in a greenhouse or growth chamber environment. In another aspect, the disclosure provides for methods of dwarfing plant growth by utilizing a composition or method described herein. The disclosure further provides for methods described herein wherein a plant growth regulator is used to restrict plant growth in order to enable more consistent and/or accurate plant feature testing and plant property testing and to mitigate the effects of insufficient light and/or overcrowding. The disclosure also provides plants, plant parts, and seeds having improved characteristics to facilitate testing or characterizing of the plants.

### BACKGROUND

There is a need for methods of limiting vertical or horizontal plant or crop growth in controlled environments, such as greenhouses, laboratories, growth chambers or space limited areas where plant properties are otherwise evaluated. When grown in controlled environments, such as greenhouses or laboratories, plants may be grown in the presence of insufficient artificial or natural light. Further, placement of growing plants in restricted areas such as seed carts, trays, or other planting compartments may limit the access of plants to the light, even when the light is sufficient. In some instances, this may also lead to limited vertical and/or horizontal growth space as the plants or crops seek space for growth. As a result, plant overcrowding may occur. Either of these scenarios can result in poor and/or inconsistent growth of plants, leading to less reliable evaluations of plant properties.

There is a need for methods of limiting vertical or horizontal plant or crop growth due to insufficient light in controlled environments, such as greenhouses, laboratories, growth chambers or space limited areas where plant properties are otherwise evaluated. When grown in these controlled environments, plants may be grown in insufficient light, and also in seed carts, trays, or other planting compartments which may limit the access of light to the plants. In some instances, each or any combination of the aforementioned scenarios this may also lead to the plants being limited by the lack of available space as the plants or crops seek space for growth. As a result, the plants may etiolate and may also collapse and contact the sides of the space, neither of which a is optimum for the performance of testing the plant properties or measuring plant features.

When plants or crops are grown in a testing or controlled environment, such as when grown in a contained space, in seed carts or trays, space limitations on vertical or horizontal growth may skew the analysis of plant properties or characteristics. This may lead to additional variables when evaluating plant properties and/or analyzing plant characteristics in a controlled testing environment.

Accordingly, the instant disclosure seeks to combat the problem of plant etiolation or overcrowding in a controlled environment which may be due to insufficient light or light quality, and/or due to limited space by controlling or limiting the size of plants or crops by utilizing a composition and method as described herein. Such an approach can control growth and avoid or mitigate etiolation or overcrowding in greenhouses, growth chambers or laboratories, especially where plants are grown in trays or in other structures with limited space.

The present disclosure also provides for compositions and methods of restricting plant growth when measuring plant features and/or plant properties by utilizing plant growth regulators as described herein. The present invention also provides seeds and plants and plant parts that can be used in the methods described herein. Methods described herein further improve homogeneity in controlled or testing environments by limiting or reducing the growth of plants or crops, thereby improving homogeneity for tests of plant properties.

### SUMMARY

The disclosure provides for a method of limiting, reducing, and/or controlling the growth of a plant or crop in a controlled testing environment comprising:
(a) treating at least one plant or seed with at least one plant growth regulator; and optionally
(b) evaluating one or more properties of the at least one plant treated with the at least one plant growth regulator.

The disclosure further provides for a method of limiting, reducing, and/or controlling the growth of a plant or crop in a controlled testing environment comprising:
(a) treating at least one plant or seed with at least one plant growth regulator;
(b) treating the at least one plant or seed with at least one herbicide and/or insecticide and/or fungicide and/or nematicide and/or another agriculturally active agent which is to be tested and optionally
(c) evaluating one or more properties of the at least one plant treated with the at least one plant growth regulator and the at least one herbicide.

The disclosure further provides for a method of improving plant growth consistency in a laboratory or greenhouse comprising
(a) treating at least one plant or seed with at least one plant growth regulator; and optionally
(b) evaluating one or more properties of the at least one plant treated with the at least one plant growth regulator.

The disclosure further provides for a method of improving plant growth consistency in a laboratory or greenhouse comprising
(a) treating at least one plant or seed with at least one plant growth regulator;
(b) treating the at least one plant or seed with at least one herbicide; and optionally
(c) evaluating one or more properties of the at least one plant treated with the at least one plant growth regulator and the at least one herbicide.

In another aspect, the disclosure provides for a method of improving the accuracy of plant property testing comprising:
(a) treating at least one plant or seed with at least one plant growth regulator; and optionally
(b) evaluating one or more properties of the at least one plant treated with the at least one plant growth regulator.

In another aspect, the disclosure provides for a method of improving the accuracy of plant property testing comprising:
(a) treating at least one plant or seed with at least one plant growth regulator;
(b) treating the at least one plant or seed with at least one herbicide; and optionally
(c) evaluating one or more properties of the at least one plant treated with the at least one plant growth regulator and the at least one herbicide.
In yet another aspect, the disclosure provides for a method of reducing or eliminating plant-to-tray, plant-to-structure, plant-to-plant contact, or plant overcrowding comprising:
(a) treating at least one plant or seed with at least one plant growth regulator;
(b) reducing or limiting the growth of plants with a plant growth regulator relative to a plant without a plant growth regulator;
(c) wherein the addition of a plant growth regulator reduces or eliminates plant-to-tray, plant-to-structure, plant-to-plant contact, or plant overcrowding relative to a plant without a plant growth regulator.

The disclosure further provides for use of a plant growth regulator to limit, reduce, or control growth of a plant in a controlled testing environment, wherein said use comprises
(a) treating at least one plant or seed with at least one plant growth regulator; and optionally
(b) evaluating one or more properties of the at least one plant treated with the at least one plant growth regulator.

The disclosure further provides for use of a plant growth regulator to limit, reduce, or control growth of a plant in a controlled testing environment, wherein said use comprises
(a) treating at least one plant or seed with at least one plant growth regulator;
(b) treating the at least one plant or seed with at least one herbicide; and optionally
(c) evaluating one or more properties of the at least one plant treated with the at least one plant growth regulator and the at least one herbicide.

The disclosure further provides for a method of improving seed harvesting in a laboratory or greenhouse comprising:
(a) treating at least one plant or seed with at least one plant growth regulator; and optionally
(b) evaluating one or more properties of the at least one plant treated with the at least one plant growth regulator.

The disclosure further provides for a method of improving seed harvesting in a laboratory or greenhouse comprising:
(a) treating at least one plant or seed with at least one plant growth regulator; and
(b) treating the at least one plant or seed with at least one herbicide; and optionally
(c) evaluating one or more properties of the at least one plant treated with the at least one plant growth regulator and the at least one herbicide.

The disclosure provides for methods of regulating plant height and/or growth in a controlled environment, such as a greenhouse or laboratory setting. It has been found that application of compositions comprising one or more plant growth regulator, also known as plant growth retardants, can limit plant growth and elongation and minimize etiolation in environments of reduced or obscure lighting.

In yet another aspect, the disclosure provides for a method of improving accuracy of plant property testing comprising treating at least one plant or seed with a composition comprising at least one plant growth regulator and evaluating one or more properties of the at least one plant treated with a plant growth regulator.

The disclosure provides for a method of improving accuracy of plant property testing comprising treating at least one plant or seed with a composition comprising at least one plant growth regulator and treating the at least one plant/seed with one or more herbicides and then evaluating one or more properties of the at least one plant treated with a plant growth regulator and one or more herbicides.

The disclosure also provides for seeds or plants or plant parts treated with a plant growth regulator that can be used in, for example, methods described herein. The disclosure also provides for seeds or plants or plant parts treated with a plant growth regulator and either sequentially (in any order) or simultaneously, treated with an herbicide, insecticide, fungicide, nematicide, and/or other agriculturally active component. The seeds and plants are preferably row crops, such as is rice, soybean, cotton, wheat, barley, sunflower, canola (oilseed rape), potato or corn, Zea mays, Sorghum, Sugarcane, alfalfa, peanuts and sugar beet. In some embodiments, the plant is other than wheat. This aspect of the invention is in contrast to standard industry practice where PGRs are not used in row crops to reduce height since row crops when grown for harvesting are generally desired to be grown as large as possible to increase yield. The seeds and plants can also be orchard crops for example a fruit, citrus, papaya, tangerine, tangelos, orange, sweet orange, lemon, lime, apple, mango, pear, apricot, cherry, peach, nectarine, or almonds. This aspect is in contrast to standard industry practice where the class of PGRs which reduce plant size are not generally used in orchards crops since orchard crops are generally desired to be grown without the use of a PGR which would reduce their size. Thus, the present invention provides use of PGRs on plants that are not known to have been used or treated with PGRs, as well as the treated seed, plant part, or plant.

In an aspect, the at least one plant growth regulator and the composition comprising at least one herbicide may be concurrently applied to the at least one plant or seed or plant part.

In another aspect, the at least one plant growth regulator may be first applied to the at least one plant or seed, followed by a composition comprising at least one herbicide.

In yet another aspect, the at least one herbicide may be first applied to the at least one plant or seed, followed by a composition comprising at least one plant growth regulator.

In an aspect, the plant or seed is selected from the group of turf grasses, forest grasses, potato, alfalfa, wheat, nuts, peanut, sunflower, corn (Zea mays), rice, barley, sugarcane, cotton, sorghum, soybean, sugar beet, canola, rapeseed, a fruit, citrus, okra, kiwifruit, strawberry, papaya, watermelon, tangerine, tangelos, orange, sweet orange, cantaloupe, melon, squash, lemon, lime, apple, mango, pear, passion fruit, apricot, cherry, peach, nectarine, almonds, and avocado. In a preferred aspect, the plant or seed is rice, soybean, cotton, wheat, sunflower, potato or corn. In another aspect, the plant or seed is other than wheat.

Any desired or known PGR can be used according to the invention. In another aspect, the at least one plant growth regulator is selected from the group consisting of cyclanilide, ancymidol, flurprimidol, paclobutrazol, uniconazole, tetcyclacis, isopyrimol, mepiquat chloride, chlormequat chloride, inabenfide, XE-1019, daminozide, ethephon, dikegulac, maleic hydrazide, tiaojiean, piproctanyl bromide, dimethipin, endothall, paraquat dichloride, thidiazuron, p-chlorophenoxyisobutyric acid, and combinations thereof. In a preferred aspect, the at least one plant growth regulator is paclobutrazol, cyclanilide, ancymidol, chlormequat chloride, uniconazole, daminozide, flurprimidol or p-chlorophenoxyisobutyric acid.

In an aspect, the at least one plant growth regulator is present at a concentration of about 0.01 ppm to about 800 ppm in the composition of the soil used to germinate the seeds, or about 0.1 ppm to about 100 ppm by weight of the composition of the soil, or about 1 to about 40 ppm of the composition of the soil. For less active PGRs concentrations for example up to and above 25000 ppm may be needed as can be determined using a process analogous to that described in the present examples.

In an aspect, the at least one plant growth regulator is present at a concentration of about 0.0625 ppm to about 800 ppm in the water used to soak the seeds before use, about 0.25 ppm to about 4 ppm by weight of the composition. For less active PGRs concentrations for example up to and above 25000 ppm may be needed as can be determined using a process analogous to those described in the examples.

In an aspect, plant growth regulator Paclobutrazol ((±)-(R*,R*)-β-[(4-Chlorophenyl)methyl]-α-(1,1-dimethylethyl)-1H-1,2,4-triazole-1-ethanol is present at a concentration of about 0.0625 ppm to about 800 ppm of the composition in the water used to soak the seeds before use, more preferably about 0.25 ppm to about 100 ppm by weight of the composition, and most preferably about 0.5 ppm to about 4 ppm by weight of the composition. In another aspect, plant growth regulator chlormequat chloride ((ClCH₂CH₂N(CH₃)₃)Cl) or Daminozide (4-(2,2-dimethylhydrazino)-4-oxo-butanoic acid) is present at a concentration of about 6ppm to about 200,000 ppm of the composition in the water used to soak the seeds before use, more preferably about 500 ppm to about 80,000 ppm by weight of the composition, and most preferably about 5000 ppm to about 5,0000 ppm by weight of the composition.

In another aspect, at least one plant growth regulator is present at a concentration of less than about 0.01% by weight of the composition, less than about 0.05% by weight of the composition, or less than about 1% by weight of the composition. In another aspect, plant growth regulator chlormequat chloride or Daminozide is present at a concentration of about 0.1% by weight of the composition, less than about 2%, or less than about 20% by weight of the composition.

In another aspect, the disclosure provides for compositions and methods comprising at least one plant growth regulator wherein said at least one plant growth regulator is present at a concentration of about 0.1% to about 20%, about 0.1% to about 10%, about 0.5% to about 5%, about 0.5% to about 3%, or about 0.1% to about 1.0% by weight of the composition. In another aspect, the disclosure provides for compositions and methods comprising at least one plant growth regulator wherein said at least one plant growth regulator is present at a concentration of about 0.1% to about 50%, about 1% to about 20%, about 5% to about 15%, or about 5% to about 10% by weight of the composition.

In another aspect, the invention provides seeds, plant parts, or plants treated with one or more PGRs and optionally a herbicide, insecticide, fungicide, nematicide, or other agriculturally active ingredient. The concentration of the PGR can be about 0.0625 ppm to about 800 ppm in the water used to soak the seeds before use, or about 0.25 ppm to about 4 ppm by weight of the composition. For less active PGRs concentrations for example up to and above 25000 ppm may be needed as can be determined using a process analogous to those described in the examples

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 provides for representative plant photos describing ratings of plants. Panel A is a Tolerant to liberty herbicide and Panel B is non-tolerant (4 days after spraying of plants with fully expanded unifoliate leaves).

FIG. 2 provides for a representative photo of plants that are tolerant of Liberty herbicide after 4 days after herbicide application to plants with fully expanded unifoliate leaves.

FIG. 3 provides a representative photo of plants grown at 340, 214 and 90 umol/m².S for 10 days without application of herbicide, showing the etiolation of plants at low light intensities.

FIG. 4 provides representative photos of plants that are both tolerant of and sensitive to Liberty herbicide 5 days after herbicide application to plants with fully expanded unifoliate leaves. The plants were grown in the absence (top row) and presence (bottom row) of a plant growth regulator (Paclobutrazol) applied at 40 ppm in the spray at the unifoliate stage together with Liberty herbicide. The outside two rows of plants in each case are plants tolerant to herbicide, and the two central rows are plants sensitive to the herbicide.

FIG. 5 provides representative photos of plants germinated from seeds pretreated (left to right) with zero and from 0.0625 to 4 ppm Bonzi for 20 hours. Seeds were treated with zero, 0.0625, 0.125, 0.25, 0.5, 1, 2 and 4 ppm Bonzi at room temperature before sowing and grown for 15 days at 90 umol/m².S.

FIG. 6 provides representative photos of isoxaflutole non-tolerant (bleached) and tolerant (green) plants grown at high light intensity, after treatment with isoxaflutole.

FIGS. 7-17 provide comparative plant height data obtained according to the method of the present invention.

### DETAILED DESCRIPTION

The disclosure provides for compositions and methods for regulating plant growth for use, for example, in a testing environment. In an aspect, the disclosure provides for compositions and methods for controlling, limiting, reducing, or dwarfing plant growth in a controlled testing environment. In another aspect, the disclosure provides for compositions and methods for controlling, limiting, reducing, or dwarfing plant growth in an environment with limited growing space for plants or crops, for example, a greenhouse, laboratory, or an area with otherwise limited or restricted growing space.

In another aspect, the disclosure provides for compositions and methods for controlling, limiting, reducing, or dwarfing plant growth in an environment with limited growing space for plants or crops, for example, a greenhouse, laboratory, or an area with otherwise limited or restricted growing space in order to improve plant growth consistency and/or homogeneity for analysis of plant properties, such as herbicide tolerance or resistance, and/or insecticidal properties.

The disclosure further provides for methods of improving plant growth consistency and/or homogeneity for analysis of plant properties, such as herbicide tolerance or resistance, and/or insecticidal properties.

In an aspect, the disclosure provides for methods of screening herbicides for effectiveness against weeds. In an aspect, a plurality of weeds is evaluated. In yet another aspect, a weed panel is evaluated utilizing a method described herein.

The disclosure further provides for methods of improving accuracy of plant test results by methods described herein.

In an aspect, methods described herein may be employed in a limited space testing environment, a greenhouse environment, or an environment wherein seed carts, trays, or other vertical growing systems are utilized. In an aspect, methods and compositions described herein may be used in an area where a plant or crop is growing or where a plant or crop will be grown.

In an aspect, the methods described herein are employed in an indoor controlled environment. In another aspect, the disclosure provides for compositions and methods comprising at least one plant growth regulator wherein said at least one plant growth regulator is present at a concentration effective to control, limit, reduce, or dwarf plant growth in a controlled testing environment, wherein the composition is not applied to a plant, seed, or crop in an outdoor environment. In an aspect, methods described herein are not employed in a field.

In an aspect of the invention, the addition of the growth regulator increases the uniformity of the plants and makes the tolerant and non-tolerant plants a similar height, which makes them more amenable to optical recognition processes especially when assaying mixed samples where the non-tolerant plants would otherwise be obscured by the continued growth of tolerant plants

In an aspect of the invention, the addition of the growth regulator increases the uniformity of the plants and makes the tolerant and non-tolerant plants a similar height, which makes them more amenable to optical recognition processes especially when assaying mixed samples where the non-tolerant plants would otherwise be obscured by the continued growth of tolerant plants, and when using an automated or mechanized greenhouse or other growth conditions.

In an aspect, where conditions employ a growth regulator, sufficient light can be between less than 50 (e.g. 10 or 25) and 90 umol/m².S, (less than approximately 3500 to 6700 lux), or between 50 and 215 umol/m².S or between 90 and 215 umol/m².S, (approximately 6700 to 15800 lux), or between 215 and 340 umol/m².S (approximately 15800 to 25000 lux) or between 340 and 550 umol/m².S (approximately 25000 lux and 40,000 lux). In another aspect, methods described herein are undertaken with more than about 40,000 lux/light, more than about 50,000 lux/light, or more than about 60,000 lux/light. In another aspect, methods described herein are undertaken with about 40,000 lux/light to about 120,000 lux/light, about 40,000 lux/light to about 100,000 lux/light, or about 40,000 lux/light to about 80,000 lux/light. In an aspect, compositions used in methods described herein, comprise a plant growth regulator. In an aspect, the plant growth regulator is selected from one or more of the group consisting of cyclanilide, ancymidol, flurprimidol, paclobutrazol, uniconazole, tetcyclacis, isopyrimol, mepiquat chloride, chlormequat chloride, inabenfide, XE-1019, chlormequat chloride, uniconazole, daminozide, ethephon, dikegulac, maleic hydrazide, tiaojiean, piproctanyl bromide, dimethipin, endothall, paraquat dichloride, thidiazuron, and p-chlorophenoxyisobutyric acid and/or combinations thereof.

In another aspect, a plant growth regulator are those that influence soil activity, absorption site on the plant, or inhibition point in gibberellin (GA) biosynthesis. In an aspect, a plant growth regulator described herein is selected from the class of (i) Onium compounds, such as chlormequat chloride, mepiquat chloride, chlorphonium, and AMO-1618, which block the cyclases copalyl-diphosphate synthase and ent-kaurene synthase involved in the early steps of GA metabolism; (ii) compounds with an N-containing heterocycle, e.g. ancymidol, flurprimidol, chlormequat chloride, uniconazole, daminozide, tetcyclacis, paclobutrazol, uniconazole-P, and inabenfide; (iii) Structural mimics of 2-oxoglutaric acid, which is the co-substrate of dioxygenases that catalyze late steps of GAformation, Acylcyclohexanediones, e.g. prohexadione-Ca and trinexapac-ethyl and daminozide, block particularly 3B-hydroxylation, thereby inhibiting the formation of highly active GAs from inactive precursors, and/or (iv) 16,17-Dihydro-GA5 and related structures act most likely by mimicking the GA precursor substrate of the same dioxygenases.

In another aspect, the disclosure provides for compositions and methods comprising at least one plant growth regulator wherein said at least one plant growth regulator is present at a concentration effective to control, limit, reduce, or dwarf plant growth in a controlled testing environment. In another aspect, the disclosure provides for compositions and methods comprising at least one plant growth regulator wherein said at least one plant growth regulator is present at a concentration of about 0.1% to about 20%, about 0.1% to about 10%, about 0.5% to about 5%, about 0.5% to about 3%, or about 0.1% to about 1.0% by weight of the composition.

In another aspect, the disclosure provides for compositions and methods comprising at least one plant growth regulator wherein said at least one plant growth regulator is present at a concentration of about 10 ppm to about 5000 ppm, about .01 ppm to about 1000 ppm, about 0.05 ppm to about 800 ppm, about 50 ppm to about 500 ppm, about 5 ppm to about 100 ppm, about 2 ppm to about 75 ppm, about 2.5 ppm to about 50 ppm, about 1 ppm to about 20 ppm, about 1 ppm to about 10 ppm, or about 0.01 to about 50 ppm. In another aspect, the plant growth regulator is present at a concentration of about 6ppm to about 200000 ppm of the composition in, more preferably about 500 ppm to about 80000 ppm by weight of the composition, and most preferably about 5000 ppm to about 50000 ppm by weight of the composition.

In yet another aspect, the disclosure provides for compositions and methods comprising at least one plant growth regulator wherein said at least one plant growth regulator comprises ancymidol at a concentration of about 2 to about 40 ppm, chlormequat chloride at a concentration of about 500 to about 3000 ppm, ethephon at a concentration of about 200 to about 1000 ppm, flurprimidol at a concentration of about 1 to about 100 ppm or 1 to about 10 ppm, paclobutrazol at a concentration of about 1 to about 50 ppm or about 1 to about 20 ppm, uniconazole at a concentration of about 1 to about 50 ppm or about 1 to about 10 ppm. In another aspect, the plant growth regulator daminozide is present at a concentration of about 6ppm to about 200,000 ppm of the composition in, more preferably about 500 ppm to about 80,000 ppm by weight of the composition, and most preferably about 5,000 ppm to about 50000 ppm by weight of the composition.

In another aspect, the plant growth regulator chlormequat chloride, is present at a concentration of about 6 ppm to about 200,000 ppm of the composition in, more preferably about 500 ppm to about 80,000 ppm by weight of the composition, and most preferably about 5,000 ppm to about 50,000 ppm by weight of the composition.

In another aspect, compositions described herein further comprise, consist of, or consist essentially of an insecticidal, herbicidal, or plant-treating composition. In yet another aspect, compositions described herein further comprise, consist of, or consist essentially of an insecticidal, herbicidal, or plant-treating composition together with a plant growth regulator described herein.

In another aspect, compositions described herein further comprise, consist of, or consist essentially of an insecticidal or fungicidal property of the plant, or other plant composition. In yet another aspect, compositions described herein further comprise, consist of, or consist essentially of an insecticidal or fungicidal property of the plant, or other plant composition, together with a plant growth regulator described herein.

In another aspect, compositions described herein further comprise, consist of, or consist essentially of an herbicide, or other plant-treating composition. In yet another aspect, compositions described herein further comprise, consist of, or consist essentially of an herbicide, or plant-treating composition together with a plant growth regulator described herein.

In an aspect, the disclosure provides for applying compositions described herein, for example, an herbicide, or plant-treating composition, and/or plant growth regulator described herein at planting, prior to planting, after planting, and/or after planting after the plant or crop begins growing.

In another aspect, a composition described herein includes one or more compositions with insecticidal and nematocidal properties, for example, Poncho®/VOTiVO™ (Bayer CropScience), Poncho® Beta (Bayer CropScience), Poncho® 600 (Bayer CropScience), Poncho® 1250+ VOTiVO™ (Pioneer), Belay® (Valent), Prosper® FX (Bayer CropScience), and/or Prosper® Evergol. In another aspect, a composition described herein includes clothianidin with a Bacillus-based compound or composition, for example, Bacillus firmus. In another aspect, the Bacillis-based compound or composition includes, for example, one or more of Bacillus cereus, Bacillus pumilis, Bacillus amyloliquefaciens, Bacillus subtilis, Bacillus subtilis strain GB03, Bacillus subtilis strain QST713.

In another aspect, a composition described herein includes one or more of glufosinate, glufosinate-ammonium, isoxaflutole, glyphosate, imazethapyr, thifensulfuron, atrazine, cyanazine, 2,4-D, dicamba, trifluralin, pendimethalin, metolachlor, simazine, propanil, acetochlor, tebuthiuron, methabenzthiazuron, amitrol, isouron, buthidazole, thiazafluron, aminopyralid, picloram, halauxifen-methyl, benazolin-ethyl, fenthiaprop-ethyl, mefenacet, azimsulfuron, difenzoquat, halosulfuron-methyl, metazachlor, pyroxasulfone, flucarbazone, mesotrione, tembotrione, bicyclopyrone, desmedipham, phenmedipham, hexazinone, metribuzin, pyrazon, bromacil, terbacil, prometryn, bentazon, bromoxynil, diuron, linuron, fluometuron, diquat, paraquat, pyrasulfotole, topramezone, clomazone, fluridone and/or indaziflam.

In an aspect, compositions described herein include an excipient.

In an aspect, compositions described herein may be formulated as a granular formulation, seed treatment, foliar composition, a foliar spray, solutions, emulsions, suspension, coating formulation, encapsulated formulation, solid, liquid, fertilizer, paste, powder, suspension, or suspension concentrate. The composition may be employed alone or in solid, dispersant, or liquid formulation. In yet another aspect, a composition described herein is formulated as a tank-mix product.

In an aspect, compositions described herein may be produced in any desired or known manner, for example by mixing the active compounds with extenders, such as liquid solvents, pressurized liquefied gases and/or solid carriers, optionally with the use of surface-active agents, such as emulsifiers and/or dispersants and/or foam formers. If the extender used is water, it may also be useful to employ for example organic solvents as cosolvents. Suitable liquid solvents include: aromatics, such as xylene, toluene or alkylnaphthalenes, chlorinated aromatics or chlorinated aliphatic hydrocarbons, such as chlorobenzenes, chloroethylenes or methylene chloride, aliphatic hydrocarbons, such as cyclohexane or paraffins, for example mineral oil fractions, alcohols, such as butanol or glycol as well as their ethers and esters, ketones, such as acetone, methyl ethyl ketone, methyl isobutyl ketone or cyclohexanone, strongly polar solvents, such as dimethylformamide and dimethyl sulphoxide, and also water. Liquefied gaseous extenders or carriers include those liquids which are gaseous at ambient temperature and at atmospheric pressure, for example aerosol propellants such as halogenated hydrocarbons and also butane, propane, nitrogen and carbon dioxide. In an aspect, solid carrier may include, for example, ground natural minerals, such as kaolins, clays, talc, chalk, quartz, attapulgite, montmorillonite or diatomaceous earth, and ground synthetic minerals, such as finely divided silica, alumina and silicates. As solid carriers for granules there are suitable: for example, crushed and fractionated natural rocks such as calcite, pumice, marble, sepiolite and dolomite, and also synthetic granules of inorganic and organic meals, and granules of organic material such as sawdust, coconut shells, maize cobs and tobacco stalks. As emulsifiers and/or foam formers there are suitable: for example, non-ionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates and protein hydrolysates. As dispersants, for example, lignosulphite waste liquors and methylcellulose are suitable.

Tackifiers such as carboxymethylcellulose and natural and synthetic polymers in the form of powders, granules or lattices, such as gum arabic, polyvinyl alcohol and polyvinyl acetate, as well as natural phospholipids, such as cephalins and lecithins, and synthetic phospholipids, can be used in the formulations. Other possible additives are mineral and vegetable oils.

Colorants such as inorganic pigments, for example iron oxide, titanium oxide and Prussian Blue, and organic dyestuffs, such as alizarin dyestuffs, azo dyestuffs and metal phthalocyanine dyestuffs, and trace nutrients such as salts of iron, manganese, boron, copper, cobalt, molybdenum and zinc, can also be used.

Any desired useful plant or crop can be treated by the method of the present invention to limit, reduce, or control the growth of a plant in a controlled testing environment.

Plants are understood as meaning, in the present context, all plants and plant populations, such as desired wild plants or crop plants (including naturally occurring crop plants). Crop plants or crops may be plants which can be obtained by conventional breeding and optimization methods or else by biotechnological and genetic engineering methods or by combinations of these methods, including the transgenic plants and including the plant varieties capable or not capable of being protected by plant breeders' rights.

In an aspect, a composition described herein may be applied to a plant or seed for example selected from corn, rice, barley, wheat, sugarcane, cotton, sorghum, soybean, sugarbeet, canola, rapeseed, a fruit, citrus, okra, kiwifruit, strawberry, papaya, watermelon, tangerine, tangelos, orange, sweet orange, cucurbits such as cantaloupe, melon and squash, lemon, lime, apple, mango, pear, passion fruit, apricot, cherry, peach, nectarine, almonds, or other orchard crops, and avocado. Treating soybean plants is particularly preferred. Treating row crops is also preferred. Treating citrus crop is also preferred.

In yet another aspect, compositions or methods described herein may be used to treat plants that grow relatively fast in a testing environment.

In an aspect, trays or seed carts for use with methods described herein are separated by about 6 inches to about 3 feet, about 6 inches to about 2 feet, about 1 foot to about 2 feet, in a horizontal or vertical direction. In an aspect, a plant or crop without a plant growth regulator, grows to about at least 9 inches to 2 feet in low light conditions, at about 8 to 15 days following sowing of seeds. In an aspect, a soybean plant without a plant growth regulator, grows to about at least 9 inches to 2 feet at about 8 to 15 days following sowing of seeds.

In an aspect, the addition of a plant growth regulator described herein reduces plant growth by about 10% or more, about 30% or more, about 50% or more, about 70% or more, or about 90% or more relative to a plant without the addition of the same plant growth regulator.

In an aspect, the addition of a plant growth regulator described herein reduces plant growth by about 10% to about 50%, about 10% to about 30%, about 20% to about 75%, or about 30% to about 60%, about 50% to about 90%, depending on the concentration used, relative to a plant without the addition of a plant growth regulator described herein.

In an aspect, the addition of a plant growth regulator described herein reduces plant growth by about 10% to about 50%, about 10% to about 30%, about 20% to about 75%, or about 30% to about 60%, about 50% to about 90% relative to a plant or seed treated with water and without the addition of a plant growth regulator described herein.

In an aspect, the percent reduction of plant growth is measured from plants after about 5 days, about 10 days, or about 20 days or more. In another aspect, the plants evaluated for plant growth are derived from seeds soaked or treated with a plant growth regulator described herein,

In an aspect, compositions and methods described herein reduce rot, browning, or general weakening of the plant caused by, for example, etiolation and/or contact with the container or other plants.

A plant growth regulator composition described herein can be applied to a soil, plant, crop, seed, leaf, or plant part thereof in a single application step. In another aspect, a composition described herein is applied to a plant, crop, seed, leaf, or plant part thereof in multiple application steps, for example, two, three, four, five or more application steps. In another aspect, the second, third, fourth, or fifth or more application steps may be with the same or different compositions. The methods described herein also provide for an aspect where multiple application steps are excluded.

A plant growth regulator composition described herein can be applied to a soil, plant, crop, seed, or plant part thereof in one or more application intervals of about a few seconds, several minutes, about 1 hour, about 2 hours, about 6 hours, about 8 hours, about 12 hours, about 1 day, about 5 days, about 7 days, about 10 days, about 12 days, about 14 days, about 21 days, or about 28 days.

A plant growth regulator composition described herein can be applied to a plant, crop, seed, or plant part thereof one or more times during a, planting or growing or harvesting cycle. In another aspect, a plant growth regulator composition described herein can be applied to a plant, crop, seed, or plant part thereof one, two, three, four, five, or six or more times per year. In another aspect, a compound or composition described herein is applied to a plant, crop, seed, or plant part thereof in one, two, three, four, or five or more times during a, planting or growing or harvesting cycle. In another aspect, a compound or composition described herein is applied to a plant, crop, seed, or plant part thereof only one time, no more than two times, or no more than three times during a, planting or growing or harvesting cycle. In yet another aspect, a compound or composition is applied in a single step to a seed. In yet another aspect, a seed described herein is planted in a one-pass application step.

In an aspect, the disclosure provides for methods of improving growth habitat, such as greenhouse growth habitat. In another aspect, the growth habitat, for example, greenhouse growth habitat, is improved by allowing for improved production and/or harvesting of seeds.

In another aspect, the disclosure provides for pre-plant, pre-emergent, post-emergent, application steps or combinations thereof. In another aspect, a compound or composition described herein is first applied in a pre-plant step and followed by one or more pre-emergent or post-emergent steps. In yet another aspect, the disclosure provides for only a pre-plant step, or one post planting step.

Methods described herein can be used in the treatment of genetically modified organisms (GMOs), e.g., plants or seeds. Genetically modified plants (or transgenic plants) are plants of which a heterologous gene has been stably integrated into the genome. The expression “heterologous gene” essentially means a gene which is provided or assembled outside the plant and when introduced in the nuclear, chloroplastic or mitochondrial genome gives the transformed plant new or improved agronomic or other properties by expressing a protein or polypeptide of interest or by downregulating or silencing other gene(s) which are present in the plant (using for example, antisense technology, cosuppression technology or RNA interference—RNAi—technology). A heterologous gene that is located in the genome is also called a transgene. A transgene that is defined by its particular location in the plant genome is called a transformation or transgenic event.

In an aspect, plants can be obtained by traditional breeding and optimization methods or by bio-technological and recombinant methods, or combinations of these methods, including the transgenic plants and including the plant varieties which are capable or not capable of being protected by Plant Breeders' Rights.

In another aspect, plant species and plant varieties which are found in the wild or which are obtained by traditional biological breeding methods, such as hybridization or protoplast fusion, and parts of these species and varieties are treated. In a further preferred embodiment, transgenic plants and plant varieties which were obtained by recombinant methods, if appropriate in combination with traditional methods (genetically modified organisms) and their parts are treated.

“Plant parts” should be understood as meaning all above ground and subsoil parts and organs of plants, such as shoot, leaf, flower, root, leaves, needles, stalks, stems, fruiting bodies, fruits and seeds, tubers and rhizomes. Plant parts also include harvested crops, and also vegetative and generative propagation material, for example cuttings, tubers, rhizomes, slips and seeds.

Seeds, plant parts, leaves, and plants may be treated via the described method by applying the compounds or compositions directly to the seed, plant part, leaf, or plant. The treated seeds, plants parts, leaves and plants also are provided by the current disclosure. In another aspect, the seed, plant part, leaf, or plant may be treated indirectly, for example by treating the environment or habitat in which the seed, plant part, leaf, or plant is exposed to. Conventional treatment methods may be used to treat the environment or habitat including dipping, spraying, fumigating, chemigating, fogging, scattering, brushing on, shanking or injecting.

According to the invention, the treatment of the plants and seeds with a plant growth regulator described herein can be carried out directly by the customary treatment methods, for example by immersion, spraying, vaporizing, fogging, injecting, dripping, drenching, broadcasting or painting, and seed treatment. For example, the seed can be treated by immersion (soaking) for 15 minutes to more than 30 hours, preferably for 30 minutes to 24 hours, more preferably 1-8 hours or overnight, most preferably 1-4 hours. In another aspect the soil, soil-less medium, or other inert substrate (for example sand, blotting paper, or Kimpak) can be treated with the PGR (for example by drenching, watering with the compound, immersion of the soil or plant in PGR solution, or via a drip feed) at the time when the seed is planted, germinating, emerging or later, more preferably at a time between planting and emergence. The drench can also be applied to batches of soil or o the soil before planting. In another aspect the drench is applied as a spray to the soil or soil-less medium, or other inert substrate. In another aspect, the PGR can be applied as a foliar application, preferably as a spray, at any time after emergence from soil or germination on a substrate, preferably when the seedlings have a cotyledon or coleoptile, or first true leaf (for example the unifoliate leaves in soybeans, first true leaf in maize).

A compound or composition described herein can take any of a variety of dosage forms including, without limitation, suspension concentrates, aerosols, capsule suspensions, cold-fogging concentrates, warm-fogging concentrates, encapsulated granules, fine granules, flowable concentrates for the treatment of seed, ready-to-use solutions, dustable powders, emulsifiable concentrates, oil-in-water emulsions, water-in-oil emulsions, macrogranules, microgranules, oil-dispersible powders, oil-miscible flowable concentrates, oil-miscible liquids, foams, pastes, pesticide-coated seed, suspoemulsion concentrates, soluble concentrates, wettable powders, soluble powders, dusts and granules, water-soluble granules or tablets, water-soluble powders for the treatment of seed, wettable powders, natural products and synthetic substances impregnated with a compound or composition described herein, a net impregnated with a compound or composition described herein, and also microencapsulations in polymeric substances and in coating materials for seed, and also ULV cold-fogging and warm-fogging formulations.

A plant growth regulator composition disclosed herein may optionally include one or more additional compounds providing an additional beneficial or otherwise useful effect. Such compounds include, without limitation, an adhesive, a surfactant, a solvent, a wetting agent, an emulsifying agent, a carrier, an adjuvant, a diluent, a dispersing agent an insecticide, a pesticide, a fungicide, a fertilizer of a micronutrient or macronutrient nature, a herbicide, a feeding inhibitor, an insect molting inhibitor, an insect mating inhibitor, an insect maturation inhibitor, a nematacide, a nutritional or horticultural supplement, or any combination thereof.

Plant growth regulator compositions described herein can be combined with a fertilizer. Examples of fertilizers capable of being used with the compositions and methods described herein include, for example, urea, ammonium nitrate, ammonium sulfate, calcium nitrate, diammonium phosphate, monoammonium phosphate, triple super phosphate, potassium nitrate, potassium nitrate, nitrate of potash, potassium chloride, muriate of potash, di- and mono-potassium salts of phosphite/phosphonate.

In an aspect, methods described herein do not include dwarfing by agitation or shaking, for example, by seismomorphogenesis.

The following examples serve to illustrate certain aspects of the disclosure and are not intended to limit the disclosure.

### EXAMPLES

### Example 1

This Example provides for a representative procedure for testing herbicide tolerance in soybean seeds. For instance, Liberty® herbicide tolerance was tested in LL27 and LL55 soybeans.

This example describes a procedure for testing, for example, soybean plants (or seed lots by grow outs of plants) for tolerance to Liberty® herbicide in a greenhouse or other location with high light intensity. Plants containing, for example the LL soybean events A2704-12 and A5547-127 are tolerant of the herbicide. Other plants that are tolerant to Liberty Herbicide could also be tested. The procedure is applicable to a wide range of plants. In this example plants that are at the unifoliate leaf stage are sprayed with herbicide. Herbicide is applied to the whole plants by spraying.

Glufosinate-ammonium, the active ingredient of Liberty Herbicide, acts by inhibition of the glutamine synthetase enzyme, which causes ammonia build-up in the cell. The ammonia is toxic to the cells of the plant. Glufosinate ammonium is not taken up efficiently by the roots, and thus must be applied to the green parts of the plant. The herbicide can be sprayed over the top of the crop to kill all non-tolerant plants. Plants to which glufosinate-ammonium has been applied at the recommended rates show symptoms within as little as 2-3 days, but this is typically 4-5 days and may take as long as 6-7 days, depending on the temperature, and light levels. Insufficient light levels can lead to difficulty in reading and interpreting the results. In addition, plants grown under low light intensity may be less sensitive to the herbicide, and so an increased amount of herbicide may be needed in order to obtain the same effect.

The below representative procedure is based on the application of Liberty® herbicide to the leaves of plants at the unifoliate leaf stage.

Plant Material

Testing of seed lots: Sow seeds in a suitable growth medium (e.g. Metromix 340) in a greenhouse at about 100-115 plants per tray. The plants are grown until they are at the unifoliate leaf growth stage. Sufficient seeds are grown to seedling stage to allow a statistically meaningful result to be obtained. The number of plants needed can be determined using SeedCalc (http://www.seedtest.org/en/content---1--1143.html) or other programs.

Growth Conditions: Plants are placed in a growth chamber, or greenhouse, or under natural lighting at approximately 30° C. day, and approximately 22° C. night with light intensity of at least 25,000 lux and preferably at least 40,000 lux for at least 16 hours a day. The plants can also be grown at higher light intensities (for example in sunlight). Insufficient light levels can lead to difficulty in reading and interpreting the results, so it is recommended that lights be available in a greenhouse depending on natural light for use in cases of extended low natural light availability. Maintain normal moisture conditions. Allow the plants to grow in the greenhouse or growth chamber until they are at the unifoliate leaf growth stage.

This representative protocol was developed using 100-115 plants per standard tray, to allow good access of the herbicide to all plant parts. If a more dense planting of seeds is desired (e.g. 200/tray), the method can be modified and evaluated accordingly.

Spray Test

Prepare herbicide solutions fresh on the day on which the plants are to be tested. Prepare a solution of Liberty® herbicide (0.18% a.i) fresh for use. This can be accomplished with the use of the commercial Liberty® herbicide product containing 24.5 percent active ingredient. Use 0.3 mL of this herbicide plus 40 mL of water and mix thoroughly. Alternatively, herbicide solutions may be made a few days to a few weeks before use, if efficacy is maintained.

Herbicide Treatment of Seedlings: The method was developed using a track sprayer with a TEEJET 8002E nozzle at 40PSI to apply the herbicide at 1.83 ft/sec (1.25 mph). The spray was applied with the nozzle positioned 15 inches above the plant canopy. Thirty-five (35) mL of the spray solution was applied to a 10 sq. ft. spray area, resulting in an effective field rate of 38.7 fluid ounces of Liberty® Herbicide per acre and a rate equivalent to 40 gal/acre. If such track sprayer equipment is not available, use a pump sprayer or other suitable sprayer such as a CO2 charged sprayer with flat nozzles calibrated to deliver the specified spray volume per acre equivalent using 40 gal/acre (35 mL per 10 sq. ft.). Nozzles such as Lurmark 30-02E80YE or TeeJet 8002EVS VisiFlo Even Flat Spray Nozzle would also be appropriate for this purpose. For sprayer configurations with a boom and multiple spray nozzles, standard flat fan nozzles may be used to deliver uniform spray coverage.

The herbicide solution can thoroughly cover the leaf surfaces. Allow the plants to dry and then return them to the greenhouse/growth room.

Untreated plants will serve as a visual reference for assessment of the treatments.

Evaluation

Plants are typically evaluated 5-7 days after applying herbicide. Tolerant plants show no effect or occasionally a small amount of yellowing (FIG. 1a, FIG. 2) and leaf edge browning depending of the specific environmental conditions. Plants are scored for tolerance (trait positive) or sensitivity (trait negative). Observations are recorded as tolerant or susceptible.

Susceptible plants will exhibit browning, drying and death of both the cotyledons and the unifoliate leaves (See, for example, FIG. 1B), as long as the cotyledons have been sufficiently exposed to the herbicide.

### Example 2

This Example provides an example of soybean plants grown in conditions of reduced light intensity. For instance, soybeans were grown using light intensities of between 90 and 340 umol/M² seconds (approximately 6700-25000 lux). FIG. 3 shows that the plants grown at lower light intensities become etiolated within 10 days.

Plant Material

Testing of seed lots: Sow seeds in a suitable growth medium (e.g. Metromix 340) in a greenhouse at about 4-50 plants per half tray.

Growth Conditions: Plants are placed in a growth chamber, at a light intensity of 90-340 umol/m2.S (6700 approximately -25000 lux) for 10 days. Maintain normal moisture conditions. Allow the plants to grow in the greenhouse or growth chamber for 10 days.

### Example 3

This Example provides for a representative procedure for testing herbicide tolerance in soybean seeds in conditions of reduced light intensity and including treatment with a growth regulator. For instance, Liberty® herbicide tolerance was tested in LL27 and LL55 soybeans using light intensities of between 90 and 340 umol/M² seconds (approximately 6700-25000 lux).

This example describes a procedure for testing, for example, soybean plants (or seed lots by grow outs of plants) for tolerance to Liberty® herbicide in a greenhouse or other location with low light intensity. Plants containing, for example the LLsoybean events A2704-12 and A5547-127 are tolerant of the herbicide. Other plants that are not tolerant to Liberty Herbicide are also tested. The procedure is applicable to a wide range of plants. In this example soybean plants that are at the unifoliate leaf stage 10 days after planting as shown in Example 2 are sprayed with herbicide and growth regulator simultaneously applied to the whole plants by spraying.

Glufosinate-ammonium, the active ingredient of Liberty Herbicide, acts by inhibition of the glutamine synthetase enzyme, which causes ammonia build-up in the cell. The ammonia is toxic to the cells of the plant. Glufosinate ammonium is not taken up efficiently by the roots, and thus must be applied to the green parts of the plant. The herbicide can be sprayed over the top of the crop to kill all non-tolerant plants. Plants to which glufosinate-ammonium has been applied at the recommended rates show symptoms within as little as 2-3 days, but this is typically 4-5 days and may take as long as 6-7 days, depending on the temperature, and light levels. In this example the difficulty in reading and interpreting the results due to low light intensity is moderated by the application of the growth regulator.

The below representative procedure is based on the application of both growth regulator and Liberty® herbicide to the leaves of plants at the unifoliate leaf stage.

Plant Material

Sow seeds in a suitable growth medium (e.g. Metromix 340) in a greenhouse at about 100-115 plants per tray. Grow the plants until they are at the unifoliate leaf growth stage. Sufficient seeds are grown to seedling stage to allow a statistically meaningful result to be obtained. The number of plants needed can be determined using SeedCalc (http://www.seedtest.org/en/content---1--1143.html) or other programs.

Growth Conditions: Plants are placed in a growth chamber, or greenhouse, at approximately 30° C. day, and approximately 22° C. night with light intensity of between 90 and 340 umol/m2/sec (approx. 67000-25000 lux depending on the light source) for, for example 16 hours a day. Maintain normal moisture conditions. Allow the plants to grow until they are at the unifoliate leaf growth stage.

This representative protocol was developed using 100-115 plants per standard tray, to allow good access of the growth regulator and herbicide to all plant parts. If a more dense planting of seeds is desired (e.g. 200/tray), the method can be modified and evaluated accordingly; when plants are grown in the presence of plant growth regulator, their reduced size may allow use of more plants per tray.

Spray Test

Prepare growth regulator and herbicide solutions fresh on the day on which the plants are to be tested. Prepare a solution of Liberty® herbicide (0.18% a.i) fresh for use. This can be accomplished with the use of the commercial Liberty® herbicide product containing 24.5 percent active ingredient. Use 0.3 mL of this herbicide plus 40 mL of water and mix thoroughly. In this example, Bonzi was added to the spray solution at 40 ppm.

Herbicide Treatment of Seedlings: The example was performed using a track sprayer with a TEEJET 8002E nozzle at 40PSI to apply the herbicide at 1.83 ft/sec (1.25 mph). The spray was applied for example with the nozzle positioned 15-18 inches above the plant canopy. Thirty-five (35) mL of the spray solution was applied to a 10 sq. ft. spray area, resulting in an effective field rate of 38.7 fluid ounces of Liberty® Herbicide per acre and a rate equivalent to 40 gal/acre. If such track sprayer equipment is not available, a pump sprayer or other suitable sprayer such as a CO2 charged sprayer with flat nozzles calibrated to deliver the specified spray volume per acre equivalent using 40 gal/acre (35 mL per 10 sq. ft.). Nozzles such as Lurmark 30-02E80YE or TeeJet 8002EVS VisiFlo Even Flat Spray Nozzle would also be appropriate for this purpose. For sprayer configurations with a boom and multiple spray nozzles, standard flat fan nozzles may be used to deliver uniform spray coverage.

The herbicide solution can thoroughly cover the leaf surfaces. Allow the plants to dry and then return them to the greenhouse/growth room.

Untreated plants will serve as a visual reference for assessment of the treatments.

Evaluation

Plants were evaluated 5 days after applying herbicide. Tolerant plants showed no effect or occasionally a small amount of yellowing leaf edge browning depending of the specific environmental conditions. Plants were photographed 5 days after treatment (FIG. 4 FIGS. 1 and 2.).

Susceptible plants exhibited browning, drying and death of both the cotyledons and the unifoliate leaves. Application of growth regulator slowed the etiolation of the tolerant plants and reduced the difference in height between tolerant and susceptible plants, thus making it easier to score the plants. (FIG. 3 and FIG. 4)

### Example 4

This Example provides for a representative procedure for testing herbicide tolerance in soybean seeds in conditions of reduced light intensity and including treatment with a growth regulator. For instance, Liberty® herbicide tolerance was tested in LL27 and LL55 soybeans using light intensities of 90 umol/M² seconds (approximately 6700 lux).

This example describes a procedure for testing, for example, soybean plants (or seed lots by grow outs of plants) for tolerance to Liberty® herbicide in a greenhouse or other location with low light intensity. Plants containing, for example the LLsoybean events A2704-12 and A5547-127 are tolerant of the herbicide. Other plants that are not tolerant to Liberty Herbicide are also tested. The procedure is applicable to a wide range of plants. In this example the soil is drenched with plant growth regulator to control the plant height and then the plants that are at the unifoliate leaf stage 10 days after planting are sprayed with herbicide—applied to the whole plants by spraying. Drenching could be applied at any time in the growth of the plants. Drenches are most optimally applied before emergence of the seedlings from the soil.

Drenches can be mixed with the soil before placing the soil in the tray or pot, or before or after planning the seeds.

The plants are planted and treated with herbicide as in example 1 except that the plants are grown at a light intensity of 90 umol/M² seconds (approximately 6700 lux).

Evaluation

Plants were evaluated 5 days after applying herbicide. Tolerant plants showed no effect or occasionally a small amount of yellowing leaf edge browning depending of the specific environmental conditions. Plants were photographed 5 days after treatment.

Susceptible plants exhibited browning, drying and death of both the cotyledons and the unifoliate leaves. Application of growth regulator as a soil drench slowed the etiolation of the plants in low light both before and after application of the herbicide and therefore reduced height of the plants, thus making it easier to score the results.

In addition, the growth regulator increases the uniformity of the plants and makes the tolerant and non-tolerant plants a similar height, which makes them more amenable to optical recognition processes especially when assaying mixed samples where the non-tolerant plants would otherwise be obscured by the continued growth of tolerant plants

Table 1 below and FIG. 7 show that the glufosinate tolerant plants remain as short as the sensitive plants when treated with the PGR, which facilitates evaluation of the results, and reduces issues due to etiolation of the tolerant plants due to continuation in growth.

### Example 5

This Example provides an example of soybean plants grown in conditions of reduced light intensity after treatment of the seeds by soaking in solutions of growth regulator. Soybeans were grown using light intensities of 90 umol/M² seconds (approximately 6700 lux). FIG. 5 shows that the application of growth regulator reduces the height of the plants

Plant Material

Pretreatment of seeds: Seeds were soaked in water or a solution of 0-4 ppm growth regulator (for example Bonzi) for 20 hours. Soaking seeds for extended periods in water may reduce germination. Therefore, the seeds can alternatively be soaked for a period of for example but not limited to 4-6 hours in between 2-4 ppm growth regulator. For other growth regulators the optimal concentration can easily be determined by this experiment.

Testing of seed lots: Sow seeds in a suitable growth medium (e.g. Metromix 340) in a greenhouse at about 4-50 plants per half tray.

Growth Conditions: Plants are placed in a growth chamber, at a light intensity of 90 umol/m².S (approx.. 6700 lux). Maintain normal moisture conditions.

In this example, the plants were grown for 15 days so as to demonstrate the effectiveness of the treatments at the time at which the plants would be evaluated for herbicide tolerance. (FIG. 5).

### Example 6

This Example provides an example of soybean plants grown in conditions of reduced light intensity after treatment of the seeds by soaking in solutions of growth regulator. Soybeans were grown using light intensities of 90 umol/M² seconds (approximately 6700 lux). Table 2 below shows that the application of growth regulator reduces the height of the plants

Plant Material

Pretreatment of seeds: Seeds were soaked in water or a solution of 0-16 ppm growth regulator (for example Bonzi) for 15 min-8 hours. Soaking seeds for extended periods in water may reduce germination. Therefore, the seeds can alternatively be soaked for a period of for example but not limited to 2-6 hours in between 4-16 ppm growth regulator. For other growth regulators the optimal concentration can easily be determined by this experiment.

Testing of seed lots: Sow seeds in a suitable growth medium (e.g. Metromix 340) in a greenhouse at about 4-50 plants per half tray.

Growth Conditions: Plants are placed in a growth chamber, at a light intensity of 90 umol/m².S (approx.. 6700 lux). Maintain normal moisture conditions.

In this example, the plants were grown for 15 days so as to demonstrate the effectiveness of the treatments at the time at which the plants would be evaluated for herbicide tolerance.

TABLE 2

| | |
|---|---|
| Duration of Bonzi Soak (16 ppm) | Percent Height Reduction |

| | | |
|---|---|---|
| 15 | min | 30% |
| 30 | min | 70% |
| 1 | hr | 80% |
| 2 | hr | 90% |
| 4 | hr | 90% |

### Example 7

This Example provides for a representative procedure for testing herbicide tolerance to IFT in soybean seeds in conditions of reduced light intensity. For instance, IFT herbicide tolerance was tested in IFT tolerant soybeans using light intensities of between 90 and 340 umol/M² seconds (approximately 6700-25000 lux).

Plants containing, for example a modified HPPD enzyme are tolerant of the herbicide. Other plants that are not tolerant to IFT Herbicide are also tested. The procedure is applicable to a wide range of plants. In this example plants that are at the expanded cotelydon stage are sprayed with herbicide. Herbicide is applied to the whole plants by spraying.

Isoxaflutole acts by inhibition of the HPPD enzyme, which causes bleaching of the plants. IFT is taken up efficiently by the shoots and roots,. The herbicide can be sprayed over the top of the crop to kill all non-tolerant plants or can be incorporated in the soil. Plants to which IFT has been applied at the recommended rates show symptoms within as little as 2-3 days, but this is typically 4-5 days and may take as long as 6-7 days, depending on the temperature, and light levels. Insufficient light levels can lead to difficulty in reading and interpreting the results. In addition, plants grown under low light intensity may be less sensitive to the herbicide, and so an increased amount of herbicide may be needed in order to obtain the same effect.

The below representative procedure is based on the application of IFT herbicide to the plants at the expanded cotelydon stage.

Plant Material

Pretreatment of seeds: Soak seeds in a water solution of 2ppm Bonzi for 15-20 hours.

Sow seeds of IFT tolerant and non-tolerant soybeans in a suitable growth medium (e.g. a pasteurized mix of three equal parts of soil, sand, and perlite) for example at ˜200 plants per tray and cover with an equal amount of sand. Alternate growing media may be used to cover the seeds as long as it does not adversely affect plant growth. Plant controls under the identical conditions or within the flats, arranged and labelled so that they can be unambiguously distinguished from the test seeds.

Place the flats in the greenhouse or growth chamber at a suitable temperature regime for robust growth, for example approximately 30° C. day, and 22° C. night. Maintain a light intensity of between 90 and 340 umol/M² seconds (approximately 6700-25000 lux) at least 14 hours a day. Without the use of growth regulators, insufficient light levels can lead to difficulty in reading and interpreting the results. Maintain normal moisture conditions. Grow the plants until they are at the expanded cotelydon stage. Sufficient seeds are grown to seedling stage to allow a statistically meaningful result to be obtained. The number of plants needed can be determined using SeedCalc (http://www.seedtest.org/en/content---1-1143. html) or other programs.

Depending on the amount of plant growth regulator applied, the plants will be between 3 and 25 cm tall. For example, if the seeds are soaked in 1-2 ppm Bonzi they may be in the range of 4-6 cm tall.

Spray Test

Prepare herbicide solutions fresh on the day on which the plants are to be tested. Using Balance Bean® herbicide prepare a stock solution from 0.5 mL Balance Bean plus 100 ml water. Prepare a working solution by adding 2 ml Stock Solution to 100 ml water, for each 20×10 inch flat. Make enough Working Solution to spray all flats.

Fill chemical sprayer with working solution and apply to samples and controls using a medium to very coarse spray. Apply the spray after emergence, and when the cotelydons have expanded but prior to unifoliates fully opening. 100mL of the spray solution is applied evenly to each flat.

A track sprayer equipment can be used if available set up to deliver the same amount of herbicide per area. Allow the plants to dry and then return them to the greenhouse/growth room.

Untreated plants can serve as a visual reference for assessment of the assessment of the plants.

The herbicide solution can thoroughly cover the leaf surfaces. Allow the plants to dry and then return them to the greenhouse/growth room.

Evaluation

Plants are typically evaluated 5-7 days after applying herbicide. Non-tolerant plants show extensive bleaching, while tolerant plants show no effect or occasionally a small amount of yellowing and leaf edge browning depending of the specific environmental conditions (FIG. 6). Observations are recorded as tolerant or susceptible.

FIG. 6 IFT shows non-tolerant (bleached) and tolerant (green) plants grown at different light intensities, after treatment with IFT.

The following representative materials were used and/or are defined in these examples. LL27 soybean corresponds to a Glufosinate soybean event also known as A2704-12 with the OECD identifier ACS-GM005-3. LL55 soybean represents a Glufosinate soybean event also known as A5547-127 with the OECD identifier ACS-GMOO6-4. LLsoybean, for example, corresponds to either LL27 or LL55 soybean (used where instructions are common to both events). Additionally, “control” represents non-herbicide-tolerant seed and LLsoybean represents glufosinate tolerant seed. Additionally, for Example 6, for example, a soybean that is tolerant to Isoxaflutole by addition of an Isoxaflutole-tolerant HPPD enzyme is used. Another example of a soybean with a mesotione tolerant HPPD enzyme is the soybean with the OECD identifier SYN-ØØØH2-5 herbicide-tolerant Soybean line. Herbicides for which resistant HPPD enzymes are available include the pyrazolones, diketonitriles and triketones.

Similarly plants tolerant of a range of herbicides are available, and the presence or absence of such herbicide tolerant or related sensitive plants can be assayed using similar protocols.

The planting trays employed in these examples are standard greenhouse planting trays, 10 inches×20 inches, and other trays and pots can be used. An example of a track sprayer is the DeVries Manufacturing Generation III Research Sprayer with a TEEJET 8002E or Lurmark 30-02E80YE nozzle, other equivalent sprayers can be used. A pump sprayer can be used (aP CO2 powered sprayer with a suitable flat spray nozzle is preferred Isoxaflutole can be applied with a coarser nozzle than Liberty.

Liberty® herbicide was used in a 24.5% ai (glufosinate) solution, the spray solution was produced by mixing 0.3 mL Liberty® Herbicide and 40 mL water. This solution contains 0.18% ai.

Isoxaflutole (IFT) herbicide was also used to treat seedling plants of Soybean as an indicator of the presence of an IFT tolerance trait (such as conferred by a herbicide-tolerant HPPD (4-Hydroxyphenylpyruvate dioxygenase) protein). Balance Bean® herbicide (40% ai.) was used to prepare the spray solution which contained approximately 05 g//L (0.004% Isoxaflutole a.i.). Approximately 5 mg a.i. was applied per tray.

Bonzi commercial plant growth regulator (a.i. paclobutrazol) was used at a number of concentrations, applied either as a soil drench, a spray, or as a soak for the seeds. Other plant growth regulators can be used—the present examples, such as Example 5 shows how the optimum concentration to use can be determined.

### Example 8

This example describes a procedure for testing, for example, soybean plants (or seed lots by grow outs of plants) for tolerance to Liberty® herbicide in a greenhouse or other location with low light intensity. Plants containing, for example the LLsoybean events A2704-12 and A5547-127 are tolerant of the herbicide. Other plants that are not tolerant to Liberty Herbicide are also tested. The procedure is applicable to a wide range of plants. In this example plants that are at the unifoliate leaf stage 10 days after planting as shown in Example 2 are sprayed with herbicide. Herbicide is applied to the whole plants by spraying.

Glufosinate-ammonium, the active ingredient of Liberty Herbicide, acts by inhibition of the glutamine synthetase enzyme, which causes ammonia build-up in the cell. The ammonia is toxic to the cells of the plant. Glufosinate ammonium is not taken up efficiently by the roots, and thus must be applied to the green parts of the plant. The herbicide can be sprayed over the top of the crop to kill all non-tolerant plants. Plants to which glufosinate-ammonium has been applied at the recommended rates show symptoms within as little as 2-3 days, but this is typically 4-5 days and may take as long as 6-7 days, depending on the temperature, and light levels. Insufficient light levels can lead to difficulty in reading and interpreting the results. In addition, plants grown under low light intensity may be less sensitive to the herbicide, and so an increased amount of herbicide may be needed in order to obtain the same effect.

The below representative procedure is based on the application of Liberty® herbicide to the leaves of plants at the unifoliate leaf stage.

Plant Material

Pretreatment of seeds: Soak seeds in water or a solution of 2ppm Bonzi for 15-20 hours.

Sow seeds in a suitable growth medium (e.g. Metromix 340) in a greenhouse at about 100-115 plants per tray. Grow the plants until they are at the unifoliate leaf growth stage. Sufficient seeds are grown to seedling stage to allow a statistically meaningful result to be obtained. The number of plants needed can be determined using SeedCalc (http://www.seedtest.org/en/content---1--1143.html) or other programs.

Growth Conditions: Plants are placed in a growth chamber, or greenhouse, at approximately 30° C. day, and approximately 22° C. night with light intensity of between 90 and 300 umol/m²/sec (approx. 67000-22000 lux depending on the light source) for, for example 16 hours a day. Maintain normal moisture conditions. Allow the plants to grow until they are at the unifoliate leaf growth stage. Depending on the amount of plant growth regulator applied, the plants will be between 3 and 30cm tall. For example, if the seeds are soaked in 1-2ppm Bonzi they may be in the range of 5-8cm tall.

This representative protocol was developed using 100-115 plants per standard tray, to allow good access of the herbicide to all plant parts. If a more dense planting of seeds is desired (e.g. 200/tray), the method can be modified and evaluated accordingly; when plants are grown in the presence of plant growth regulator, their reduced size may allow use of more plants per tray.

Spray Test

Prepare herbicide solutions fresh on the day on which the plants are to be tested. Prepare a solution of Liberty® herbicide (0.18% a.i) fresh for use. This can be accomplished with the use of the commercial Liberty® herbicide product containing 24.5 percent active ingredient. Use 0.3 mL of this herbicide plus 40 mL of water and mix thoroughly. Alternatively, herbicide solutions may be made a few days to a few weeks before use, if efficacy is maintained.

Herbicide Treatment of Seedlings: The method was developed using a track sprayer with a TEEJET 8002E nozzle at 40PSI to apply the herbicide at 1.83 ft/sec (1.25 mph). The spray was applied with the nozzle positioned 15 inches above the plant canopy. Thirty-five (35) mL of the spray solution was applied to a 10 sq. ft. spray area, resulting in an effective field rate of 38.7 fluid ounces of Liberty® Herbicide per acre and a rate equivalent to 40 gal/acre. If such track sprayer equipment is not available, use a pump sprayer or other suitable sprayer such as a CO2 charged sprayer with flat nozzles calibrated to deliver the specified spray volume per acre equivalent using 40 gal/acre (35 mL per 10 sq. ft.). Nozzles such as Lurmark 30-02E80YE or TeeJet 8002EVS VisiFlo Even Flat Spray Nozzle would also be appropriate for this purpose. For sprayer configurations with a boom and multiple spray nozzles, standard flat fan nozzles may be used to deliver uniform spray coverage.

The herbicide solution can thoroughly cover the leaf surfaces. Allow the plants to dry and then return them to the greenhouse/growth room.

Untreated plants will serve as a visual reference for assessment of the treatments.

Evaluation

Plants are typically evaluated 5-7 days after applying herbicide. Tolerant plants show no effect or occasionally a small amount of yellowing and leaf edge browning depending of the specific environmental conditions. Plants are scored for tolerance (trait positive) or sensitivity (trait negative). Observations are recorded as tolerant or susceptible. Plants showing some dieback but with green cotyledons are scored as trait positive.

Score any plants that show dieback of the main meristem and re-initiation from the cotyledonary node). These plants are scored as trait-positive (tolerant). This behavior is seen in certain high maturity group >4) LL27 varieties and is indicative of tolerance in the field. This behavior has not been observed in LL55 varieties.

Susceptible plants will exhibit browning, drying and death of both the cotyledons and the unifoliate leaves as the cotyledons have been sufficiently exposed to the herbicide

### Example 9

This Example provides for a representative procedure for testing herbicide tolerance in soybean plants in conditions of reduced light intensity and including treatment with a growth regulator. For instance, Isoxafluotol herbicide tolerance was tested in soybeans using light intensities of between 90 and 340 umol/M2 seconds (approximately 6700-25000 lux). Higher light intensities, for example 600 umol/M2 seconds including up to full daylight (˜2000-6000 umol/M2) can also be used—the reduction in plant height is also beneficial at these higher light intensities.

The seeds are soaked with PGR before planting, as described in other examples, or a drench applied to the soil. The plants are typically grown in standard 1020 horticultural flats with holes for drainage, and a soil-containing or soilless medium. Plants are placed in a growth chamber, or greenhouse, for example at approximately 30° C. day, and approximately 22° C. night with light intensity of between 90 and 340 umol/m2/sec (approx. 67000-25000 lux depending on the light source) for, for example, 16 hours a day. Maintain normal moisture conditions.

Seeds can be assayed for tolerance to other herbicides in a comparable manner.

In this example plants that are at the cotyledon stage to before first unifoliate emergence are sprayed with herbicide. Plants expressing a tolerant HPPD gene (for example) are tolerant to the herbicide Isoxafluotol, and may also be tolerant to topramezone, mesotrione, tembotrione, or bicyclopyrone or related compounds with a similar mode of action. Other plants that are not tolerant to one of these herbicides will respond by bleaching of the leaves.

Application of growth regulator slowed the etiolation of the tolerant plants and reduced the difference in height between tolerant and susceptible plants, thus making it easier to score the plants. In addition, the growth regulator increases the uniformity of the plants which makes them more amenable to optical recognition processes.

### Example 10

This Example provides an example of soybean plants grown in conditions of reduced light intensity after treatment of the plants with growth regulators with different modes of action. Soybeans were grown as described in example 5 using light intensities of between 80-100 umol/M² seconds (approximately 6700 lux). In this example, the growth regulators Bonzi , Cycocel B-nine were applied 4 days after planting as a drench to the soil. They can also be applied to the seed by soaking. In this example, Bonzi was applied as a drench at 2 ppm, and Cycocel and B-Nine at 25,000 ppm. Table 3 below and FIG. 8 show the results of these treatments. As with plants treated with Bonzi, plants treated with other growth regulators in this way can be used for test of herbicide tolerance and other characteristics, such as resistance to insects, or for testing insecticides or fungicides for activity on the plants. Furthermore, the treatment with growth regulator increases the uniformity of the plants which makes them more amenable to optical recognition processes.

The following representative materials were used and/or are defined in these examples. LL27 soybean corresponds to a Glufosinate soybean event also known as A2704-12 with the OECD identifier ACS-GM005-3. LL55 soybean represents a Glufosinate soybean event also known as A5547-127 with the OECD identifier ACS-GMOO6-4. LL soybean, for example, corresponds to either LL27 or LL55 soybean (used where instructions are common to both events). Additionally, “control” represents non-tolerant seed and LLsoybean represents tolerant seed

The planting trays employed in this example are standard greenhouse planting trays, 10 inches×20 inches. The track sprayer is (e.g. DeVries Manufacturing Generation III Research Sprayer with a TEEJET 8002E nozzle) or equivalent, the pump sprayer utilized was (Pump or CO2 powered sprayer preferred) with a suitable flat spray nozzle (see section 6b(ii), Liberty® herbicide was used in a 24.5% ai solution, the spray solution was produced by mixing 0.3 mL Liberty® Herbicide and 40 mL water. This solution contains 0.18% active ingredient.

### Example 11

### Canola Example

This Example provides an example of two varieties Canola (Brassica rapa, oilseed rape) plants grown in conditions of high and reduced light intensity. The plants were grown using light intensities of between 80-100 umol/M² seconds (low light) and 290-310 umol/M² seconds (high light).

Table 4 below and FIG. 9 show that the plants grown in low light are about 60% taller 11 days after planting than grown in the high light conditions. In a further experiment, the Canola plants were treated with a soil drench of Bonzi at 16 ppm. The plants were drenched 4 days after sowing with 40 mL per cell (720 mL per flat) and measured at 12 days after sowing. Table 5 below and FIG. 10 show that the plants treated with the growth regulator were about 70% shorter.

This treatment reduced the height of plants grown under low light conditions by about 75% 11 days after planting. These plants can then be sprayed with herbicide to determine herbicide tolerance or treated with other active compounds to determine the effect on the plants, (such as use of a fungicide or insecticide) without excessive etiolation. This difference in height persists during further growth.

Testing of seed lots: Seeds were in a suitable growth medium (e.g. a Soilless peat-based potting mix such as Metromix 340) in a greenhouse at about 4 plants per 18 cell deep flat insert. Seeds can also be germinated or grown in other suitable soil-based or soil-less media, including for example germination paper, towels, crepe cellulose paper or Kimpak/Versapak.

Growth Conditions: Plants were placed in a growth chamber, at a light intensity of 80-100 umol/m².S (low light) or 290-310 umol/M² seconds (high light). Normal moisture conditions were maintained.

For treatment of plants with a drench, a solution of 16 ppm Bonzi was prepared and applied to each deep flat insert.

In this example, the plants were grown for 11 days so as to demonstrate the effectiveness of the treatments at the time at which the plants would be evaluated for herbicide tolerance. The results are in the two graphs below (Table 4 and Table 5).

In a further experiment, the Canola seeds are planted on germination paper soaked with Bonzi at concentration between 0.001 and 0.5 ppm in a small enclosed container, or in trays which are irrigated as necessary. This treatment reduces the height of plants grown under low light conditions by about significant amount. These plants are also treated with herbicides (for example Glufosinate, Glyphosate, Isoxaflutole, imidazolinone, mesotrione, or other herbicides such as group 14 or group 27 herbicides) present in the medium, or applied as a spray, and plants that are not tolerant to the herbicide are killed by the herbicide or exhibit clearly changed characteristics (such as changes in growth, bleaching etc.). This difference in height allows the plants to be grown in small containers for example.

### Example 12

### Cotton Example

This Example provides an example of cotton plants grown in conditions of reduced light intensity after treatment of the seeds by soaking in solutions of growth regulator of different concentrations for varying amounts of time, for example 1, 2 or 4 hours. Cotton seeds were soaked in water (control), and Bozi at 4 ppm or 16 ppm before growing them under low light for a period of 14 days.

Seeds were sown in a suitable growth medium (e.g. a Soilless peat-based potting mix such as Metromix 340) in a greenhouse at about 4 plants per 18 cell deep flat insert. Seeds can also be germinated or grown in other suitable soil-based or soil-less media.

Growth Conditions: Plants were placed in a growth chamber, at a light intensity of 80-100 umol/m².S (low light). Normal moisture conditions were maintained.

Table 6 below and FIG. 11 show that the application of growth regulator can be carried out using various concentrations and duration of soaking the seeds and reduces the height of the plants compared to untreated plants. Plants treated with Bonzi or other growth regulators in this way can be used for test of herbicide tolerance and other characteristics.

### Example 13

This Example provides an example of Zea mays (corn, maize) plants grown in conditions of reduced light intensity after treatment of the seeds by soaking in solutions of growth regulator of different concentrations for varying amounts of time, for example 1, 2 or 4 hours. Zea nays seeds were soaked in water (control), and Bozi at 4 ppm or 16 ppm before growing them under low light.

Seeds were sown in a suitable growth medium (e.g. a Soilless peat-based potting mix such as Metromix 340) in a greenhouse at about 4 plants per 18 cell deep flat insert. Other growth methods can be used, such as flats plugs etc. and other soil-based or soil-less media.

Growth Conditions: Plants were placed in a growth chamber, at a light intensity of 80-100 umol/m².S (low light). Normal moisture conditions were maintained.

Table 7 below and FIG. 12 show that the application of growth regulator to Zea mays seeds can be carried out using various concentrations and duration of soaking the seeds and reduces the height of the plants compared to untreated plants. Plants treated with Bonzi or other growth regulators in this way can be used for test of herbicide tolerance and other characteristics. Table 7 and FIG. 12 show the height of the first leaf collar (top of black bars) and the second leaf collar (top of bar) collars measured on the plants after 12 days of sowing.

### Example 14

This Example provides an example of using plants grown after treatment of the seeds by soaking in solutions of growth regulator or by soil drench for the testing of active ingredients for herbicidal activity. Seeds are soaked in Bozi at a suitable concentration for 1-24 hours before growing them for a period sufficient to prepare them for testing with herbicides. Plants grown for testing of potential herbicides are often tall and difficult to handle, especially for automated systems. Treatment with a growth regulator allows the plants to be shortened so that they are easier to handle and assess. Typical plants used for this purpose may be plants such as common weeds and row crop or other agricultural plants.

### Example 15

This example describes a procedure for testing, for example, sunflower plants (or seed lots by grow outs of plants) for tolerance to herbicide in a greenhouse or other location with high, intermediate or low light intensity. Certain Sunflower varieties are tolerant to, for example, imidazolinone and sulfonylurea herbicides. Other plants that are not tolerant to such herbicides are also tested. The procedure is applicable to a wide range of plants. In this example the seeds are soaked in plant growth regulator (PGR) or soil is drenched with PGR to control the plant height and then the plants that are at the appropriate leaf stage are treated with herbicide—applied for example to the whole plants by spraying, or by drenching the soil. Drenching with PGR could be applied at any time in the growth of the plants. Drenches are usually applied before or soon after emergence of the seedlings from the soil. Drenches can be mixed with the soil before placing the soil in the tray or pot, or before or after planting the seeds.

The plants are grown at a light intensity of 80-100 umol/M² seconds or can be grown at lower or higher light intensities. Even at high light intensities, a reduction in plant height can be obtained from treating the plants with PGRs.

Plants are evaluated the appropriate amount of time after applying the herbicide—depending whether it kills the plants quickly (1-2 days), or takes several days, or longer. Tolerant plants show no effect or occasionally a small amount of effect depending of the specific environmental conditions. Application of growth regulator slows the etiolation of the plants in low or higher light levels both before and after application of the herbicide and therefore reduces height of the plants, thus making it easier to score the results, and makes the plants more uniform and less likely to fall over, thus making the process easier to adapt to image recognition systems.

### Example 16

This example describes a procedure for testing, for example, rice plants (or seed lots by grow outs of plants) for tolerance to herbicide in a greenhouse or other location with high, intermediate or low light intensity. Certain rice varieties are tolerant to, for example, imidazolinone and sulfonylurea herbicides. Other plants that are not tolerant to such herbicides are also tested. In this example the seeds are soaked in PGR or soil is drenched with PGR to control the plant height and then the plants that are at the appropriate leaf stage are treated with herbicide—applied for example to the whole plants by spraying, or by drenching the soil. Drenching with PGR could be applied at any time in the growth of the plants. Drenches are usually applied before or soon after emergence of the seedlings from the soil. Drenches can be mixed with the soil before placing the soil in the tray or pot, or before or after planting the seeds. Seeds can also be germinated or grown in other suitable soil-based or soil-less media, including for example germination paper, towels, crepe cellulose paper or Kimpak/Versapak, and the seeds soaked, or the PGR added to the growth media at various times as appropriate.

The plants are grown at a light intensity of for example 80-100 umol/M² seconds or can be grown at lower or higher light intensities. Even at high light intensities, a reduction in plant height can be obtained from treating the plants with PGRs.

Plants were evaluated the appropriate amount of time after applying the herbicide—depending whether it kills the plants quickly (1-2 days), or takes several days, or longer. Tolerant plants show no effect or occasionally a small amount of effect depending of the specific environmental conditions. Application of growth regulator slows the etiolation of the plants in low or higher light levels both before and after application of the herbicide and therefore reduces height of the plants, thus making it easier to score the results, and makes the plants more uniform, thus making the process easier to adapt to image recognition systems.

### Example 17

This example provides an example of corn plants grown in conditions of reduced light intensity and including treatment with growth regulators. Herbicide resistant corn seeds were soaked in water (control) and Cycocel (chlormequate chloride) at rates of 2500 ppm-10000 ppm for 4 hrs.

Seeds were sown in a suitable growth medium (e.g. a Soilless peat-based potting mix such as Metromix 340) in a greenhouse at about 6 plants per 18 cell deep flat insert. Seeds can also be germinated or grown in other suitable soil-based or soil-less media.

Growth Conditions: Plants were placed in a growth chamber, at a light intensity of 80-100 umol/m².S (low light). Normal moisture conditions were maintained.

The Table (Table 8) below and FIG. 13 show that the application of PGRs with multiple modes of action and application can be used to reduce the height of plants compared to the untreated plants. Plants were measured to the height of the first leaf collar (top of black bars) and the second leaf collar (top of bar). Plants treated with Cycocel or other growth regulators in this way can be used to test herbicide tolerance and other characteristics.

### Example 18

This example provides an example for testing herbicide tolerance in corn plants grown in conditions of reduced light intensity and including treatment with growth regulators. Herbicide resistant corn seeds were soaked in water (control) and Bonzi at a rate of 2 ppm for 4 hrs. They were grown under low light conditions and sprayed with glufosinate or glyphosate when most seedlings had a fully emerged true leaf, in this case, at 6 days after planting.

Seeds were sown in a suitable growth medium (e.g. a Soilless peat-based potting mix such as Metromix 340) in a greenhouse at about 6 plants per 18 cell deep flat insert. Seeds can also be germinated or grown in other suitable soil-based or soil-less media.

Growth Conditions: Plants were placed in a growth chamber, at a light intensity of 80-100 umol/m².S (low light). Normal moisture conditions were maintained.

Plants were evaluated 5 days after applying herbicide. Even with the use of PGRs, tolerant plants showed no effect or occasionally a small amount of yellowing or browning leaf edge but remained tolerant to the herbicide. Table 9 below and FIG. 14 show that the application of Bonzi as a soak application can be used to reduce the height of plants compared to the untreated. Plants treated with Bonzi or other growth regulators in this way can be used to test herbicide tolerance and other characteristics.

### Example 19

This example provides an example of soy plants grown in conditions of reduced light intensity and including treatment with growth regulator with multiple modes of action. Herbicide resistant corn seeds were soaked in water (control), a 1% rate of Cycocel (chlormequate chloride), and a 1% rate of B-Nine (Daminozide) 2 hrs.

Seeds were sown in a suitable growth medium (e.g. a Soilless peat-based potting mix such as Metromix 340) in a greenhouse at about 6 plants per 18 cell deep flat insert. Seeds can also be germinated or grown in other suitable soil-based or soil-less media.

Growth Conditions: Plants were placed in a growth chamber, at a light intensity of 80-100 umol/m².S (low light). Normal moisture conditions were maintained.

Table 10 below and FIG. 15 show that the application of PGRs with multiple modes of action and application can be used to reduce the height of plants compared to the untreated. Plants treated with Cycocel or other growth regulators in this way can be used to test herbicide tolerance and other characteristics.

### Example 20

This example provides an example for testing herbicide tolerance in soybean plants in conditions of reduced light intensity and including treatment with growth regulators. Herbicide intolerant wildtype varieties were sown scattered amongst herbicide tolerant soybean seeds—1 wildtype seed to 5 tolerant seeds. At 4 days after planting or when ˜80% of the seeds had emerged, the seeds were drenched with Bonzi at a rate of 2 ppm using 30 ml per well or 540 ml per flat. They were grown under low light conditions and sprayed with glufosinate at 7 days after planting when most seedlings were at the unifoliate stage.

Seeds were sown in a suitable growth medium (e.g. a Soilless peat-based potting mix such as Metromix 340) in a greenhouse at about 6 plants per 18 cell deep flat insert. Seeds can also be germinated or grown in other suitable soil-based or soil-less media.

Growth Conditions: Plants were placed in a growth chamber, at a light intensity of 80-100 umol/m².S (low light). Normal moisture conditions were maintained.

Plants were evaluated 7 days after applying herbicide. Even with the use of PGRs, tolerant plants showed no effect or occasionally a small amount of yellowing or browning leaf edge but remained tolerant to the herbicide. Herbicide intolerant wildtype plants died completely as expected. Table 11 below and FIG. 16 show that with the application of a Bonzi drench plant height is significantly reduced in plants that are both tolerant and intolerant to herbicides. Plants treated with Bonzi or other growth regulators in this way can be used to test herbicide tolerance and other characteristics. In addition, use of growth regulators to reduce plant height has the effect that tolerant and non-tolerant plants remain a similar size thus enabling easier characterization of the plant response. Such pants are also easier to recognize using optical recognition systems, and may be easier to manipulate in an automated greenhouse, growth chamber or other controlled testing environment.

### Example 21

This Example provides an example cotton plants grown in conditions of high and reduced light intensity. The plants were grown using light intensities of between 80-100 umol/M² seconds (low light) and 290-310 umol/M² seconds (high light). Table 12 below and FIG. 17 show that the plants grown in low light are significantly taller 9 days after planting than grown in the high light conditions.

1. (canceled)

2. A method of testing herbicide tolerance in a plant, comprising:
(a) treating at least one plant or seed with at least one plant growth regulator;
(b) treating the at least one plant or seed with at least one herbicide; and
(c) testing herbicide tolerance in the at least one plant or seed.

3. The method of claim 2, wherein the plant or seed is corn, rice, sugarcane, cotton, sorghum, soybean, sugarbeet, canola, rapeseed, a fruit, citrus, okra, kiwifruit, strawberry, papaya, watermelon, tangerine, tangelos, orange, sweet orange, cantaloupe, melon, squash, lemon, lime, apple, mango, pear, passion fruit, apricot, cherry, peach, nectarine, almonds, or avocado.

4. (canceled)

5. (canceled)

6. (canceled)

7. (canceled)

8. The method of claim 2, wherein the at least one plant growth regulator is selected from the group consisting of cyclanilide, ancymidol, flurprimidol, paclobutrazol, uniconazole, tetcyclacis, isopyrimol, mepiquat chloride, chlormequat chloride, inabenfide, XE-1019, daminozide, ethephon, dikegulac, maleic hydrazide, tiaojiean, piproctanyl bromide, dimethipin, endothall, paraquat dichloride, thidiazuron, p-chlorophenoxyisobutyric acid, and combinations thereof.

9. (canceled)

10. (canceled)

11. (canceled)

12. (canceled)

13. (canceled)

14. (canceled)

15. (canceled)

16. (canceled)

17. The method of claim 2, wherein the plant or crop is not grown or evaluated in a field.

18. The method of claim 2, wherein the plant or crop is a transgenic plant or crop.

19. The method of claim 2, wherein the at least one plant growth regulator and the composition comprising at least one herbicide are concurrently applied to the at least one plant or seed.

20. The method of claim 2, wherein the at least one plant growth regulator is first applied to the at least one plant or seed, followed by the composition comprising at least one herbicide.

21. The method of claim 2, wherein the at least one herbicide is first applied to the at least one plant or seed, followed by the composition comprising at least one plant growth regulator.

22. The method of claim 2, wherein the at least one herbicide is glufosinate, glufosinate-ammonium, isoxaflutole, glyphosate, imazethapyr, thifensulfuron, atrazine, cyanazine, 2,4-D, dicamba, trifluralin, pendimethalin, metolachlor, simazine, propanil, acetochlor, tebuthiuron, methabenzthiazuron, amitrol, isouron, buthidazole, thiazafluron, aminopyralid, picloram, halauxifen-methyl, benazolin-ethyl, fenthiaprop-ethyl, mefenacet, azimsulfuron, difenzoquat, halosulfuron-methyl, metazachlor, pyroxasulfone, flucarbazone, mesotrione, tembotrione, bicyclopyrone, desmedipham, phenmedipham, hexazinone, metribuzin, pyrazon, bromacil, terbacil, prometryn, bentazon, bromoxynil, diuron, linuron, fluometuron, diquat, paraquat, pyrasulfotole, topramezone, clomazone, fluridone and/or indaziflam.

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. (canceled)

86. A method for evaluating herbicide tolerance comprising treating at least one plant or seed with at least one herbicide, wherein the at least one plant or seed is grown under a light intensity from 90 to 340 umol/M²seconds, or at a higher light intensity such as up to about 2000 μmol/M²seconds.

87. The method according to claim 86, wherein the at least one herbicide is glufosinate, glufosinate-ammonium, isoxaflutole, glyphosate, imazethapyr, thifensulfuron, atrazine, cyanazine, 2,4-D, dicamba, trifluralin, pendimethalin, metolachlor, simazine, propanil, acetochlor, tebuthiuron, methabenzthiazuron, amitrol, isouron, buthidazole, thiazafluron, aminopyralid, picloram, halauxifen-methyl, benazolin-ethyl, fenthiaprop-ethyl, mefenacet, azimsulfuron, difenzoquat, halosulfuron-methyl, metazachlor, pyroxasulfone, flucarbazone, mesotrione, tembotrione, bicyclopyrone, desmedipham, phenmedipham, hexazinone, metribuzin, pyrazon, bromacil, terbacil, prometryn, bentazon, bromoxynil, diuron, linuron, fluometuron, diquat, paraquat, pyrasulfotole, topramezone, clomazone, fluridone and/or indaziflam.

88. (canceled)

89. (canceled)

90. The method according to claim 86, wherein the at least one plant or seed comprises a modified HPPD enzyme.

91. (canceled)

92. The method of claim 86, wherein the at least one plant or seed is corn, rice, barley, sugarcane, cotton, sorghum, soybean, sugarbeet, canola, rapeseed, a fruit, citrus, okra, kiwifruit, strawberry, papaya, watermelon, tangerine, tangelos, orange, sweet orange, cantaloupe, melon, squash, lemon, lime, apple, mango, pear, passion fruit, apricot, cherry, peach, nectarine, almonds, or avocado.

93. (canceled)

94. A method for evaluating herbicide tolerance in a plant, comprising:
(a) applying to a plant or seed at least one herbicide,
(b) growing the plant in a location with light intensity of at least 25,000 lux for at least 16 hours per day, wherein said location is at a temperature from 22° C. to 30° C.;
(c) allowing the plant to grow until the unifoliate leaf growth stage; and
(d) evaluating the plant 5, 6, or 7 days after applying the at least one herbicide.

95. The method of claim 94, wherein the plant is a soybean plant.

96. The method of claim 94, wherein the at least one herbicide is glufosinate-ammonium.

97. The method of claim 94, wherein the at least one herbicide is applied to the whole plant by spraying.

98. The method of claim 2, wherein the plant or seed are treated with the plant growth regulator by soaking.

99. The method of claim 2, wherein the plant growth regulator is applied by drenching, watering with the compound, immersion of the soil or plant in plant growth regulator solution, or via a drip feed.

100. (canceled)

101. The method of claim 2, wherein the concentration of the at least one plant growth regulator is between 0.5 and 500 ppm.

102. (canceled)

103. (canceled)

104. (canceled)

105. (canceled)

106. (canceled)

107. (canceled)
